(19) United States
(12) Patent Application Publication
(10) Pub. No.: US 2004/0088822 A1
(43) Pub. Date: May 13, 2004

(54) Hydraulic door closer

(75) Inventor: Jack Huang, Taoyuan Hsien (TW)

Correspondence Address: BACON & THOMAS, PLLC, 625 SLATERS LANE, FOURTH FLOOR, ALEXANDRIA, VA, 22314

(73) Assignee: Heng Kuo Co., Ltd., Taoyuan Hsien (TW)

(21) Appl. No.: 10/700,489

(22) Filed: Nov. 5, 2003

Related U.S. Application Data
(63) Continuation-in-part of application No. 09/982,843, filed on Oct. 16, 2001.

(51) Int. Cl. E05F 3/14

(52) U.S. Cl. 16/60

(57) ABSTRACT

A door closer includes a casing having a recess in which a base is received, and a first cylinder and a second cylinder are in communication with the recess. A passage is in communication between the first and second cylinders so as to allow the hydraulic oil to flow between the two cylinders. The base includes a driving shaft for being connected to a door. A first rod and a second rod are pivotably connected to the base and respectively inserted in the first and second cylinders. A threaded rod is connected to a distal end of the first rod and a first spring is mounted to the first rod and the threaded rod. A sleeve is threadedly engaged with the threaded rod and an operation rod is securely connected to the sleeve so that when rotating the operation rod, the first spring is adjusted by moving the sleeve relative to the threaded rod.

This is a Continuation-In-Part application for U.S. patent application 09/982,843, filed on Oct. 16, 2001.

### FIELD OF THE INVENTION

### BACKGROUND OF THE INVENTION

A conventional door closer known is disclosed in U.S. Pat. No. 6,493,904 which includes two cylinders in a casing and two pistons are respectively and movably received in the cylinders. The two pistons are biased by two springs and a baffle contacts two respective ends of the two springs. An adjustment block is fixed connected to the baffle and a first end of an adjustment rod is connected to the block. A second end of the adjustment rod can be operated by the user so as to compress both of the springs to adjust the restoration forces of the two springs. In other words, although there are two springs in the closer, they cannot be adjusted individually. This limits the number of functions that the springs may have. Another conventional door closer is disclosed in U.S. Pat. No. 5,829,097 and includes two springs which are able to be adjusted by rotating a knob located at an end of the closer. However, the knob is located between a side of the door and the doorframe, and only very limited space allows the user to access the knob. Besides, the door closer includes a complicated structure that increases the manufacturing cost and the time of assembly. Yet another conventional door closer is disclosed in U.S. Pat. No. 5,802,670 which includes only one spring and the only one spring is compressed by a movable adjusting sleeve. The only one spring obviously performs only one function which makes the door to be opened and closed at the same speed.

The present invention intends to provide a door closer that includes two springs and only one of which is adjusted so that the two springs play different roles during operation of the door closer.

### SUMMARY OF THE INVENTION

In accordance with one aspect of the present invention, there is provided a door closer which comprises a casing having a recess and a first cylinder and a second cylinder are in communication with the recess. A passage is in communication between the first and second cylinders so that hydraulic oil may flow between the two cylinders.

A base is received in the recess and has a driving shaft to be connected to a door. A first rod and a second rod are pivotably connected to the base and respectively inserted in the first and second cylinders. A threaded rod is connected to a distal end of the first rod and a first spring is mounted to the first rod and the threaded rod. A sleeve has a threaded inner periphery which is engaged with the threaded rod. An operation rod is securely connected to the sleeve and an end member is rotatably connected to the operation rod and seals the first cylinder. A second spring is mounted to the second rod and a piston is connected to a distal end of the second rod. An end piece seals the second cylinder.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the door closer of the present invention;

FIG. 2 is a cross sectional view to show the door closer of the present invention;

FIG. 2-1 shows the first spring is compressed by rotating the operation rod;

FIG. 3 is an exploded view to show the second rod, the threaded rod, the sleeve, and the operation rod of the door closer of the present invention, and

FIG. 4 shows two valves which control the volume of hydraulic oil through the passage.

### DETAILED DESCRIPTION OF THE PREFERRED EMBODIMENT

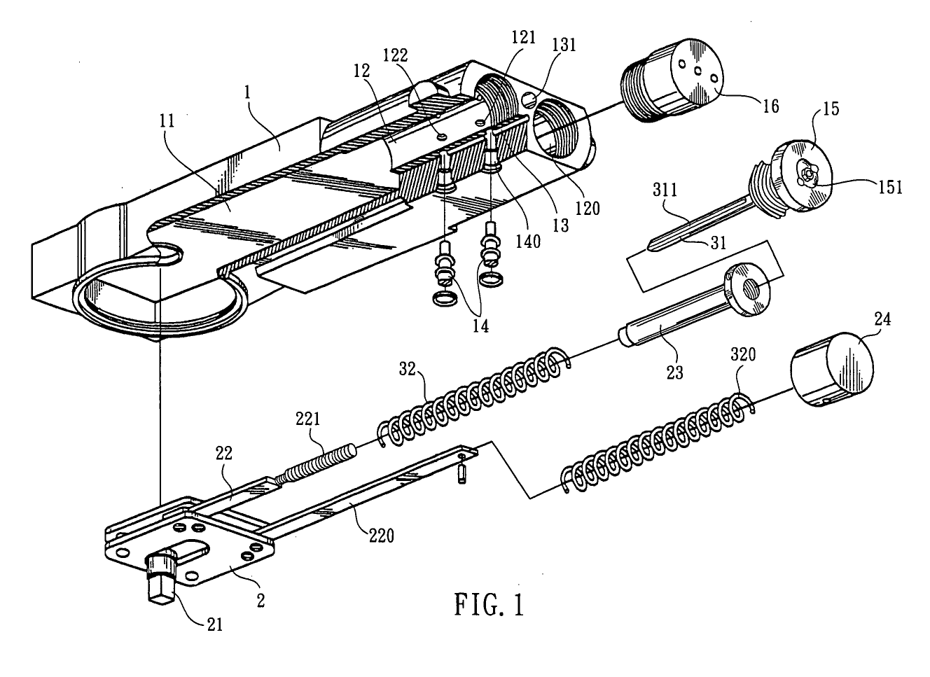

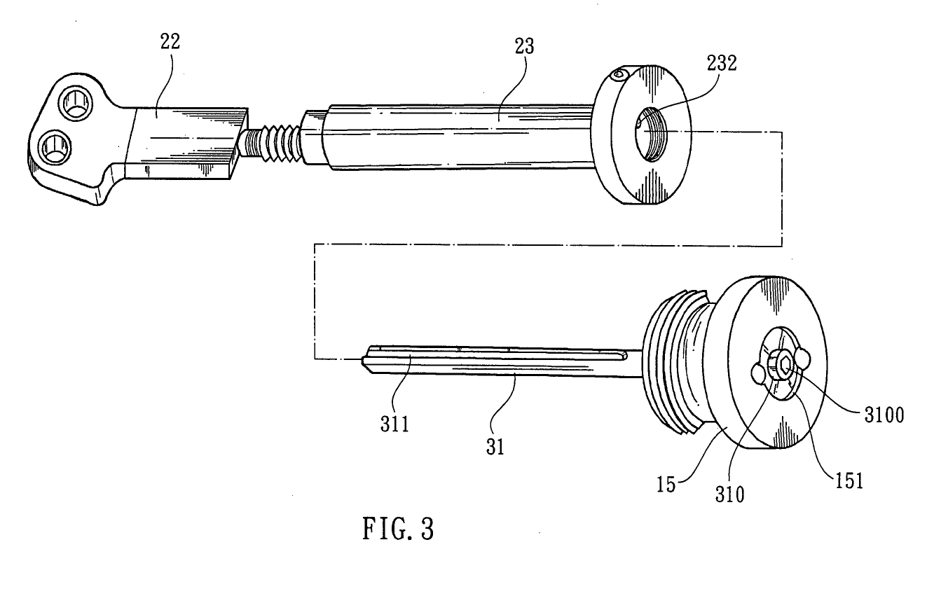

Referring to FIGS. 1, 2 and 3, the door closer of the present invention comprises a casing 1 having a recess 11 defined therein so that a base 2 is received in the recess 11 and located at a first end of the casing 1. A first cylinder 12 and a second cylinder 120 are in communication with the recess 11. A first passage 13 and a second passage 131 are defined in the casing 1. A first sub-passage 122 is defined in communication with the first passage 13, and a second sub-passage 121 is defined in communication with the second passage 131, so that the hydraulic oil may flow into the two cylinders 12, 120 during the operation of the closer.

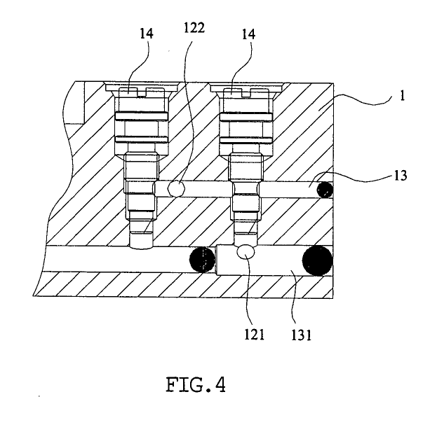

Further referring to FIG. 4, two valves 14 are engaged with two openings 140 transversely defined in the casing 1 and respectively communicating with the first passage 13 and the first sub-passage 122, and the second passage 131 and the second sub-passage 121. The valves 14 control the volume of the hydraulic oil that enters into the two cylinders 12 and 120.

The base 2 includes a driving shaft 21 extending therefrom so as to be connected to a door which is not shown. A first rod 22 and a second rod 220 are pivotably connected to the base 2 and respectively inserted in the first and second cylinders 12, 120. A threaded rod 221 is connected to a distal end of the first rod 22 and a first spring 32 is mounted to the first rod 22 and the threaded rod 221. A sleeve 23 has a threaded inner periphery 231 and the threaded rod 221 is threadedly engaged with the threaded inner periphery 231 of the sleeve 23. The sleeve 23 has a flange such that the first spring 32 is biased between a shoulder portion of the first rod 22 and the flange of the sleeve 23. An operation rod 31 has an end thereof rotatably engaged with a hole 151 defined through an end member 15 which seals the first cylinder 12. A knob 310 extends from the end of the operation rod 15 and a polygonal recess 3100 is defined in the knob 310 so that a tool can be used to rotate the operation rod 15 by engaging the polygonal recess 3100. The knob 310 is located at a second end of the casing 1 so as to be easily accessed by the users. The operation rod 31 has at least one longitudinal groove 311 defined in an outer periphery thereof and a boss 232 extends from an inner periphery of the sleeve 23 so that the boss 232 is engaged with the groove 311. By the engagement, when the operation rod 31 is rotated, the sleeve 23 is rotated relative to the threaded rod 221 and the first spring 32 is compressed by the movement of the sleeve 23.

A second spring 320 is mounted to the second rod 220 and a piston 24 is connected to a distal end of the second rod 220. An end piece 16 seals the second cylinder 120.

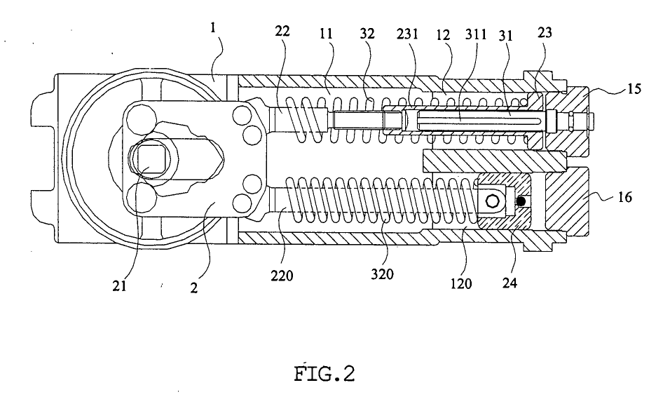

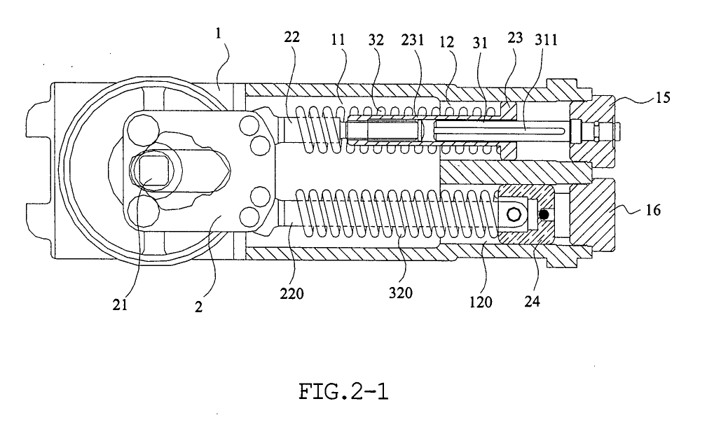

As shown in FIG. 2-1, when rotating the operation rod 31, the sleeve 23 moves along the threaded rod 221 so that the first spring 32 is can be adjusted. The knob 310 is located at an end of the casing 1 and opposite to the driving shaft 21 so that the user is easily to operate the operation rod 31.

While we have shown and described the embodiment in accordance with the present invention, it should be clear to those skilled in the art that further embodiments may be made without departing from the scope of the present invention.

What is claimed is:

1. A door closer comprising:
a casing having a recess defined therein and a first cylinder and a second cylinder being in communication with the recess, a passage being in communication between the first and second cylinders, and
a base received in the recess and located close to a first end of the casing, the base including a driving shaft extending therefrom, the driving shaft adapted to be connected to a door, a first rod and a second rod pivotably connected to the base and respectively inserted in the first and second cylinders, a threaded rod connected to a distal end of the first rod and a first spring mounted to the first rod and the threaded rod, a sleeve having a threaded inner periphery and the threaded rod threadedly engaged with the threaded inner periphery of the sleeve, an operation rod having a first end securely connected to the sleeve and an end member rotatably connected to a second end of the operation rod and sealing the first cylinder, the second end of the operation rod located at a second end of the casing, a second spring mounted to the second rod and a piston connected to a distal end of the second rod, an end piece sealing the second cylinder.

2. The door closer as claimed in claim 1, wherein the operation rod has at least one longitudinal groove defined in an outer periphery thereof and a boss extends from an inner periphery of the sleeve, the boss engaged with the groove.

3. The door closer as claimed in claim 1, wherein the end member includes a hole defined therethrough and the second end of the operation rod is engaged with the hole, a polygonal recess defined in the end of the operation rod.
